(19) United States
(12) Patent Application Publication
(10) Pub. No.: US 2005/0273233 A1
(43) Pub. Date: Dec. 8, 2005

(54) In-vehicle electronic apparatus and method for displaying digital broadcast in the same

(76) Inventor: Koji Sekine, Iwaki-city (JP)

Correspondence Address: BRINKS HOFER GILSON & LIONE, P.O. BOX 10395, CHICAGO, IL, 60610, US

(21) Appl. No.: 11/144,385

(22) Filed: Jun. 2, 2005

(30) Foreign Application Priority Data
Jun. 7, 2004 (JP) 2004-168069

(51) Int. Cl. G06F 17/00

(52) U.S. Cl. 701/36; 701/1

(57) ABSTRACT

An in-vehicle digital broadcast receiving apparatus includes a display, a traveling detection unit that determines whether or not a vehicle in which the in-vehicle digital broadcast receiving apparatus is installed is traveling, and a video decoding unit including an auxiliary data extractor and a display controller. The auxiliary data extractor extracts auxiliary data other than moving picture data from received digital broadcast data. The display controller causes the auxiliary data extracted by the extractor to be displayed on the display when the traveling detection unit determines that the vehicle is traveling. Thus, auxiliary data included in a digital broadcast can be displayed on the display even while traveling unless doing so would interfere with safety.

### BACKGROUND OF THE INVENTION

1. Field of the Invention

The present invention relates to an in-vehicle electronic apparatus having a digital broadcast receiving function, and, in particular, to displaying digital broadcasts while the vehicle is traveling.

2. Description of the Related Art

Recently, digital audio and video broadcasting, such as digital terrestrial broadcasting, mobile broadcasting, and digital satellite broadcasting, has advanced. Such broadcast media in in-vehicle applications are considered in view of their standardization, and are expected by manufacturers in various fields, such as in-vehicle electronic apparatus manufacturers, to be popular future products.

An in-vehicle television system or video system of the related art limits the displaying of moving pictures, e.g., television images, during traveling in order to ensure the safety of the driver. The in-vehicle television/video system determines whether or not the vehicle is traveling based on parking information, etc., and permits a received television broadcast or a DVD image to be displayed on a display screen only when it is determined that the vehicle is parked. For example, as shown in FIG. 11, when the vehicle is parked, a television image is displayed on a display, whereas, when the vehicle is traveling, a blue background or a pure blue screen is displayed or the screen view on the display is turned off.

Japanese Unexamined Patent Application Publication No. 2001-94897 discloses a receiving apparatus in which a broadcast-type code is extracted from on-air program information provided in a digital broadcast, and audio playback of the program is automatically selected depending upon the traveling state of the vehicle. Limiting the display of television images during traveling prevents sufficient information from being obtained from the broadcast, however. In order to overcome such a limitation, this receiving apparatus allows automatic playback of secondary audio channel.

However, such an in-vehicle television/video system of the related art for receiving digital broadcasts has the following problems. Even if a television broadcast is currently being received, as shown in FIG. 11, a typical in-vehicle apparatus limits displaying television images or provides a blue background when the vehicle travels, and outputs only audio information during traveling. For information acquisition from video media, therefore, this in-vehicle apparatus does not allow for sufficient acquisition of visual information, and resorts only to audio information. Television broadcast stations do not expect the use of audio information in an environment without video, which is expected in radio audio broadcasts, and therefore do not provide audio information without video so as to allow for sufficient information acquisition. During traveling, the secondary audio playback function described in the above-noted publication is not sufficient for users.

In digital terrestrial broadcasting or digital satellite broadcasting, it is expected to broadcast video data and auxiliary data superimposed thereon, such as data indicating the program details and other attached data. However, users are not allowed to sufficiently enjoy such data services on typical in-vehicle television/video apparatuses because of the limitation on viewing data even if they receive the data during traveling. Such typical in-vehicle television/video apparatuses are therefore difficult for users to use or may not be useful.

### SUMMARY OF THE INVENTION

Accordingly, it is an object of the present invention to provide an in-vehicle electronic apparatus and a method for displaying a digital broadcast in the same, capable of providing as much as possible of the data included in the digital broadcast to a user unless doing so would interfere with safety while the vehicle is traveling.

In one aspect of the present invention, an in-vehicle electronic apparatus having a function for receiving a digital broadcast includes a display, a traveling detection unit that determines whether or not a vehicle in which the in-vehicle electronic apparatus is installed is traveling, an auxiliary data extraction unit that extracts auxiliary data other than moving picture data from received digital broadcast data, and a display control unit that causes the auxiliary data extracted by the auxiliary data extraction unit to be displayed on the display when the traveling detection unit determines that the vehicle is traveling.

In another aspect of the present invention, a method for displaying an image in an in-vehicle electronic apparatus having a function for receiving a digital broadcast includes the steps of determining whether or not a vehicle in which the in-vehicle electronic apparatus is installed is traveling, and displaying auxiliary data other than moving picture data included in a received digital broadcast on a display when it is determined that the vehicle is traveling.

According to the present invention, therefore, when a digital broadcast is reproduced in the vehicle cabin while the vehicle is traveling, the in-vehicle electronic apparatus allows not only sound to be output but also auxiliary information, such as a data broadcast, to be displayed, thus achieving information acquisition with high usability and comfort level for the user. In the related art, an in-vehicle electronic apparatus turns off the display screen or shows a blue background or a logo on the screen, and only permits the user to hear a broadcast during traveling. On the other hand, the in-vehicle electronic apparatus according to the present invention allows the auxiliary data to be displayed unless doing so would interfere with safe driving, thus increasing the amount of information the user can acquire and achieving a user-friendly product design.

### BRIEF DESCRIPTION OF THE DRAWINGS

FIG. 1 is a block diagram of an in-vehicle digital broadcast receiving apparatus according to a first embodiment of the present invention;

FIG. 2 is a block diagram of a video decoding unit;

FIG. 3 is a data structure diagram of digital broadcast data;

FIG. 4A is a data format of a PAT;

FIG. 4B is a data format of a PMT;

FIG. 5 is a table showing parameters of a PAT;

FIG. 6 is a table showing parameters of a PMT;

FIG. 7 is a flowchart showing the operation of the in-vehicle digital broadcast receiving apparatus according to the first embodiment;

FIG. 8 is an illustration of a display view according to the first embodiment;

FIG. 9 is a block diagram of an in-vehicle navigation apparatus according to a second embodiment of the present invention;

FIGS. 10A and 10B are illustrations of display views according to the second embodiment; and

FIG. 11 is an illustration of a display view in an in-vehicle television/video apparatus of the related art.

### DESCRIPTION OF THE PREFERRED EMBODIMENTS

An in-vehicle electronic apparatus according to the present invention is preferably implemented as an in-vehicle digital broadcast receiving apparatus for receiving digital broadcasts. Embodiments of the present invention will be described in detail hereinbelow with reference to the drawings.

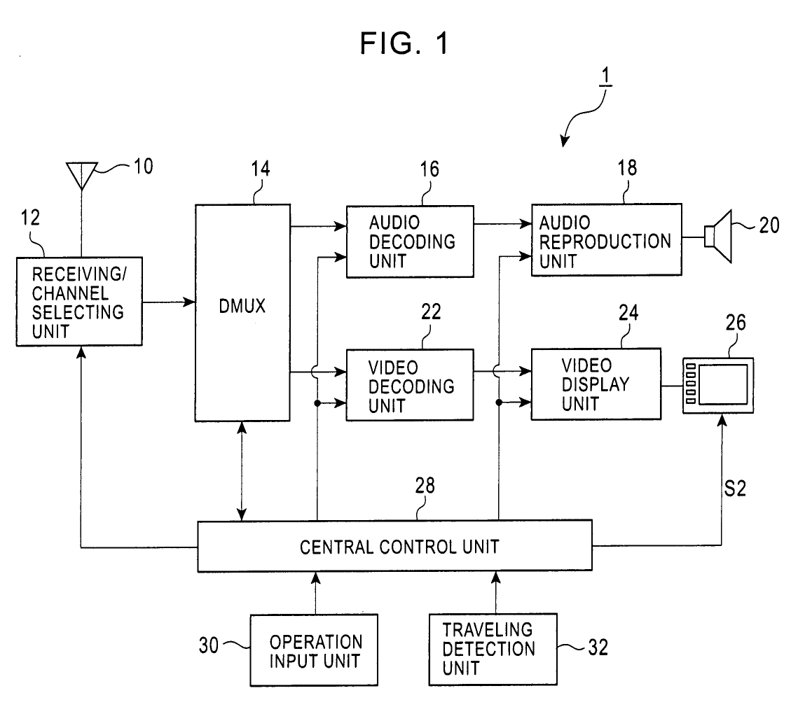

FIG. 1 is a block diagram of a digital broadcast receiving apparatus 1 according to a first embodiment of the present invention. The digital broadcast receiving apparatus 1 includes an antenna 10 for receiving digital terrestrial broadcasts or digital satellite broadcasts, a receiving/channel selecting unit 12 that decodes and descrambles a digital broadcast received by the antenna 10, a demultiplexer 14 that demultiplexes a data stream received from the receiving/channel selecting unit 12 into an audio signal and a video signal, an audio decoding unit 16 that decodes the audio signal from the demultiplexer 14, an audio reproduction unit 18 that performs necessary reproduction processing on the decoded audio signal, a loudspeaker 20 that converts the reproduced audio signal into an audible sound, a video decoding unit 22 that decodes the video signal, a video display unit 24 that controls the display of the decoded video signal, a display 26 on which the video signal is displayed, a central control unit 28 that controls the components, an operation input unit 30 via which a user operation is entered, and a traveling detection unit 32 that detects a traveling state of the vehicle.

The audio reproduction unit 18 preferably includes a digital-to-analog (D/A) converter that converts the digital audio signal into an analog audio signal, and an amplifier that amplifies the analog audio signal. Preferably, the video display unit 24 includes a frame memory, and modifies or combines the video signal so as to correspond to the frame of the display 26. The operation input unit 30 is a user interface for receiving an instruction to select a channel to be received, volume adjustment, and switching of views on the display 26, and provides these inputs to the central control unit 28. The traveling detection unit 32 supplies a detection result of a vehicle speed sensor in the vehicle or on/off information of a parking brake to the central control unit 28.

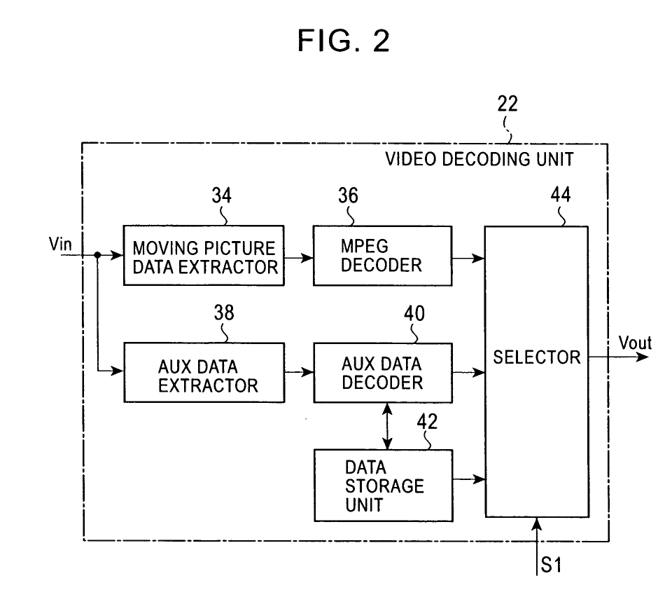

FIG. 2 shows the internal structure of the video decoding unit 22. The video decoding unit 22 includes a moving picture data extractor 34 that extracts moving picture data from a video signal Vin received from the demultiplexer 14, an MPEG (moving picture expert group) decoder 36 that decodes the extracted moving picture data, such as MPEG data, an auxiliary data extractor 38 that extracts auxiliary data other than the moving picture data from the video signal Vin, an auxiliary data decoder 40 that decodes the extracted auxiliary data, a data storage unit 42 that stores the decoded auxiliary data or preset image data, and a selector (or display controller) 44 that receives the outputs from the MPEG decoder 36, the auxiliary data decoder 40, and the data storage unit 42 and produces a video signal Vout in response to a control signal S1 from the central control unit 28.

The auxiliary data is data superimposed on the moving television picture data in a digital broadcast, including text data describing the details of a program, data related to the content used in the program, road and traffic data, weather forecast or news data, electronic program data related to the program schedules of channels, and still image data.

The main feature of the in-vehicle digital broadcast receiving apparatus according to the first embodiment is to limit the displaying of moving television pictures during traveling and to display the auxiliary data on the display 26. Since the auxiliary data contains less motion than moving pictures, the auxiliary data displayed on the display 26 during traveling does not compromise the user's safety, but allows the user to acquire as much of the received information as possible.

The structure of the data received in a digital broadcast will now be described.

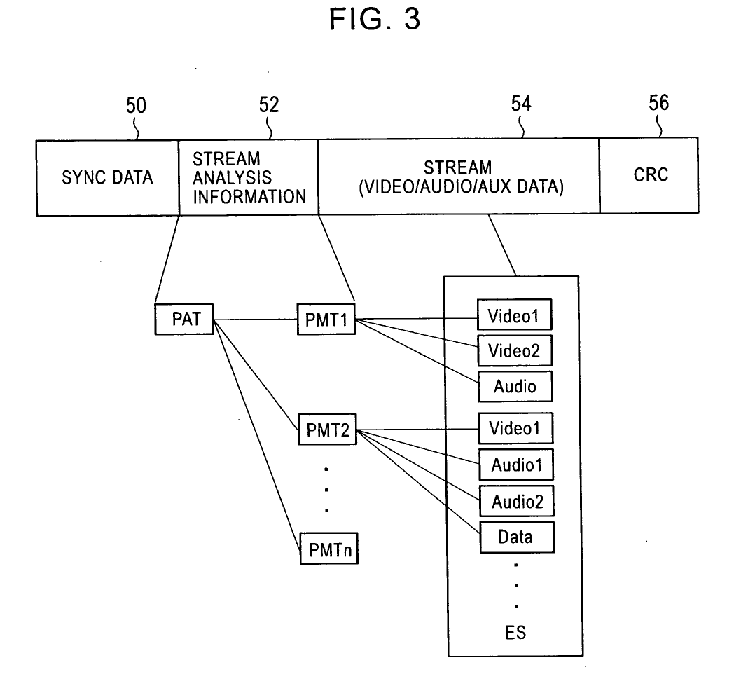

FIG. 3 shows a schematic data format of one frame of data in the digital broadcast. The frame data is composed of synchronization data 50, stream analysis information 52, a stream 54, and cyclic redundancy check (CRC) data 56. The stream analysis information 52 includes program association table (PAT) information for managing programs included in the stream 54. The PAT has a plurality of program map tables (PMTs) PMT1, PMT2, . . . PMTn as sub-table information for managing data constituting the programs, such as audio and video (AV) data. The PAT and the PMTs are referred to when the data stream is analyzed in the demultiplexer 14 and the video decoding unit 22.

The stream 54 includes an elementary stream (ES) composed of video data (Video), audio data (Audio), and auxiliary data (Data), and each data is grouped. The management information for the grouped data is included in the PMTs PMT1 to PMTn. For example, the PMT PMT1 manages video data Video1 and Video2, and audio data Audio, and the PMT PMT2 manages video data Video1, audio data Audio1 and Audio2, and auxiliary data Data.

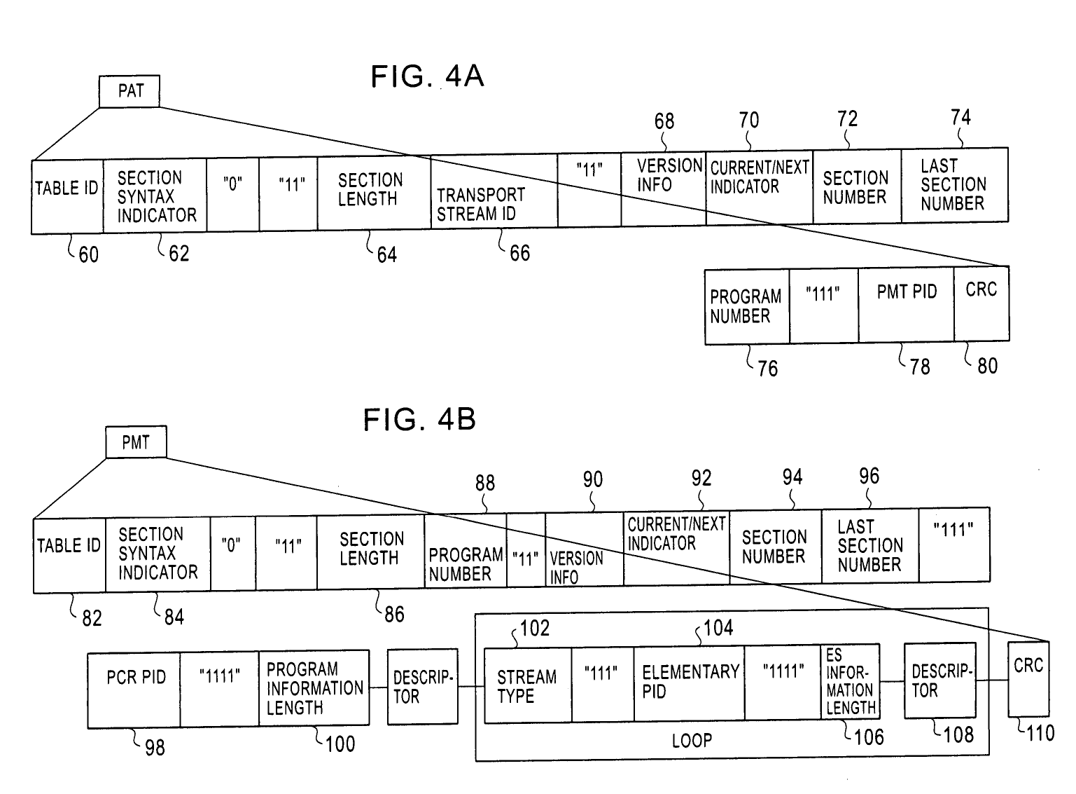

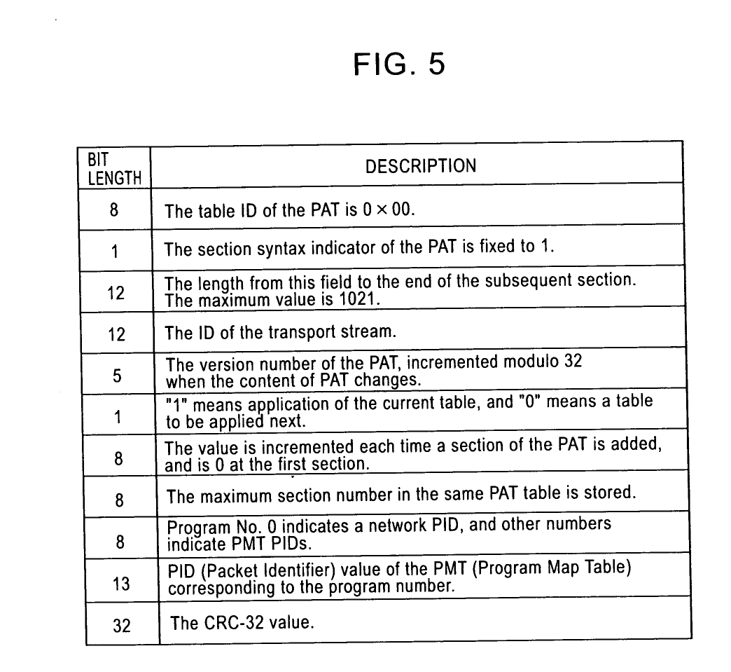

As shown in FIG. 4A, the PAT data format includes a table ID 60, a section syntax indicator 62, a section length 64, a transport stream ID 66, a version number 68, a current/next indicator 70, a section number 72, a last section number 74, a program number 76, a PMT PID 78, and a CRC 80. The details of these PAT parameters are described in a table shown in FIG. 5.

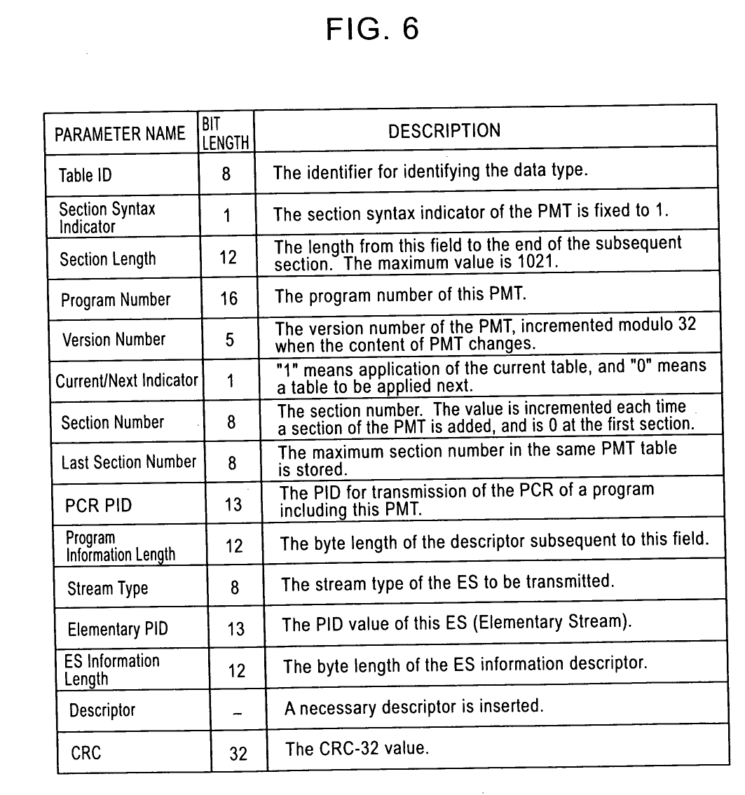

As shown in FIG. 4B, the PMT data format includes a table ID 82, a section syntax indicator 84, a section length 86, a program number 88, a version number 90, a current/next indicator 92, a section number 94, a last section number 96, a PCR PID 98, a program information length 100, a stream type 102, an elementary PID 104, an ES information length 106, a descriptor 108, and a CRC 110. The details of these PMT parameters are described in a table shown in FIG. 6.

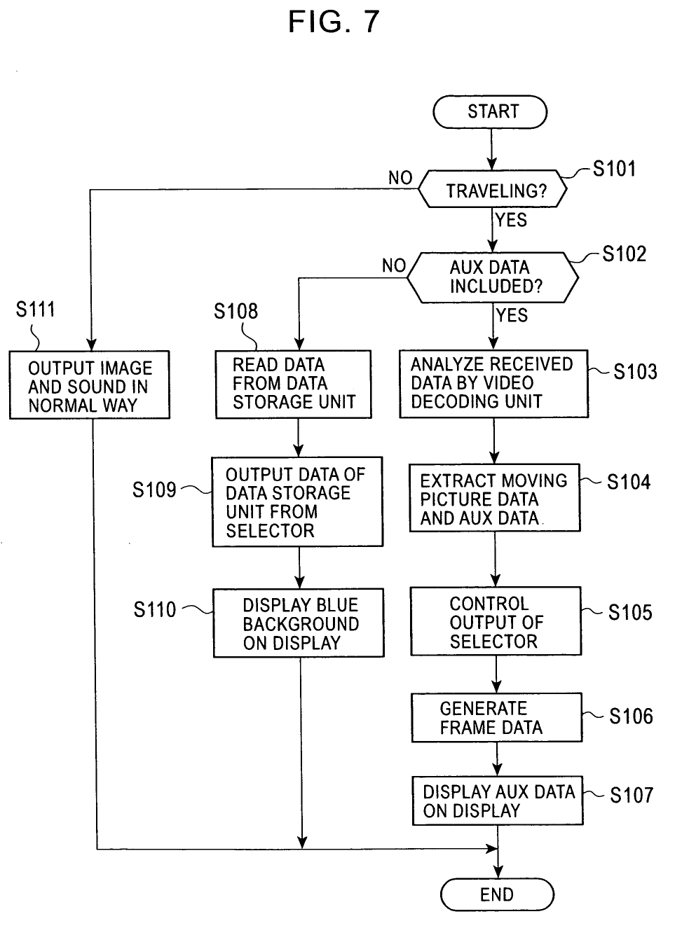

The operation performed by the in-vehicle digital broadcast receiving apparatus will be described with reference to a flowchart shown in FIG. 7. First, the central controller 28 monitors an output from the traveling detection unit 32, and determines whether or not the vehicle is traveling (step S101). For example, if the output from the traveling detection unit 32 indicates that a parking brake is turned on or that the speed of a vehicle speed sensor is zero, the central controller 28 determines that the vehicle is parked, and otherwise determines that the vehicle is traveling.

If the central controller 28 determines that the vehicle is traveling, it further determines whether or not auxiliary data is included in the digital broadcast based on the output from the demultiplexer 14 (step S102). The data stream received from the receiving/channel selecting unit 12 is separated into an audio signal and other signals by the demultiplexer 14. The demultiplexer 14 refers to the PAT and PMT management tables having the data format shown in FIG. 3 to determine whether or not auxiliary data is included in the stream 54 of one frame, and sends a determination result to the central controller 28.

If auxiliary data is included, the central controller 28 causes the video decoding unit 22 to perform data analysis so that the auxiliary data is extracted from the data stream (step S103). The video signal demultiplexed by the demultiplexer 14 is supplied to the moving picture data extractor 34 and the auxiliary data extractor 38. The moving picture data extractor 34 refers to the PAT and PMT management tables of the frame data, and extracts video corresponding to the moving picture data from the stream 54 (step S104). The auxiliary data extractor 38 also refers to the PAT and PMT management tables, and extracts the auxiliary data other than the moving picture data from the stream 54 (step S104).

The MPEG decoder 36 decodes the moving picture data, and sends the decoded data to the selector 44. The auxiliary data decoder 40 decodes the extracted auxiliary data, and sends the decoded data to the selector 44. When the vehicle is traveling, the central controller 28 supplies a control signal S1 to the selector 44 so as to provide as output only the auxiliary data. In response to the control signal S1, the selector 44 provides only the auxiliary data to the video display unit 24 (step S105). The video display unit 24 generates frame data to be displayed on the display 26 (step S106), and the auxiliary data is therefore displayed on the display 26 (step S107).

If no auxiliary data is reported from the demultiplexer 14, the central controller 28 controls the video decoding unit 22 to read the data stored in the data storage unit 42 (step S108). The data read from the data storage unit 42 is supplied to the selector 44. The central controller 28 causes the data read from the data storage unit 42 to be provided as output from the selector 44 by the control signal S1, and prohibits the moving picture data from being provided as output (step S109). The data storage unit 42 stores data, e.g., log data, still image data, and blue background data, and the data read from the data storage unit 42 is displayed on the display 26 (step S110). If auxiliary data is not included, the central controller 28 does not necessarily display image data from the data storage unit 42, and may turn off the display screen of the display 26 by a control signal S2.

If it is determined that the vehicle is parked, the central controller 28 causes the digital broadcast received through the antenna 10 to be produced in the normal way from the loudspeaker 20 and the display 26 (step S111). In this case, the video signal demultiplexed by the demultiplexer 14 is separated into and extracted as moving picture data and auxiliary data by the moving picture data extractor 34 and the auxiliary data extractor 38. The moving picture data and the auxiliary data are decoded and are then supplied to the selector 44. The central controller 28 controls both the MPEG decoder 36 and the auxiliary data decoder 40 to provide signals by a control signal S1. The video display unit 24 combines or modifies the frame data based on the moving picture data and the auxiliary data, and displays the digital broadcast on the display 26. In synchronization with the displayed broadcast, sound is produced from the loudspeaker 20.

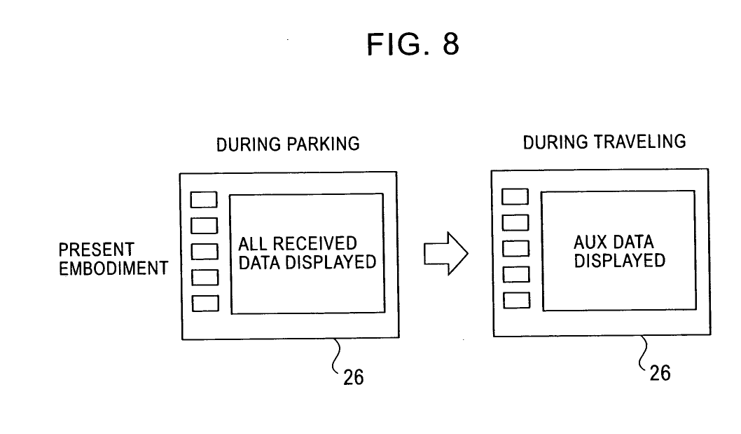

FIG. 8 shows views on the digital broadcast receiving apparatus according to the first embodiment during parking and traveling. During parking, as indicated by the left view shown in FIG. 8, all data in the received digital broadcast can be displayed on the display 26. That is, both a television image and auxiliary data can be displayed. The user is able to select viewing of both or either data through the operation input unit 30. While the vehicle is traveling, as indicated by the right view shown in FIG. 8, as described above, only the auxiliary data in the received data is displayed.

The auxiliary data is basically determined by a digital broadcast provider, or a broadcast station. For example, program information of the currently received channel (broadcast station) or program information of multiple channels (broadcast stations) can be viewed.

An in-vehicle navigation apparatus according to a second embodiment of the present invention will now be described.

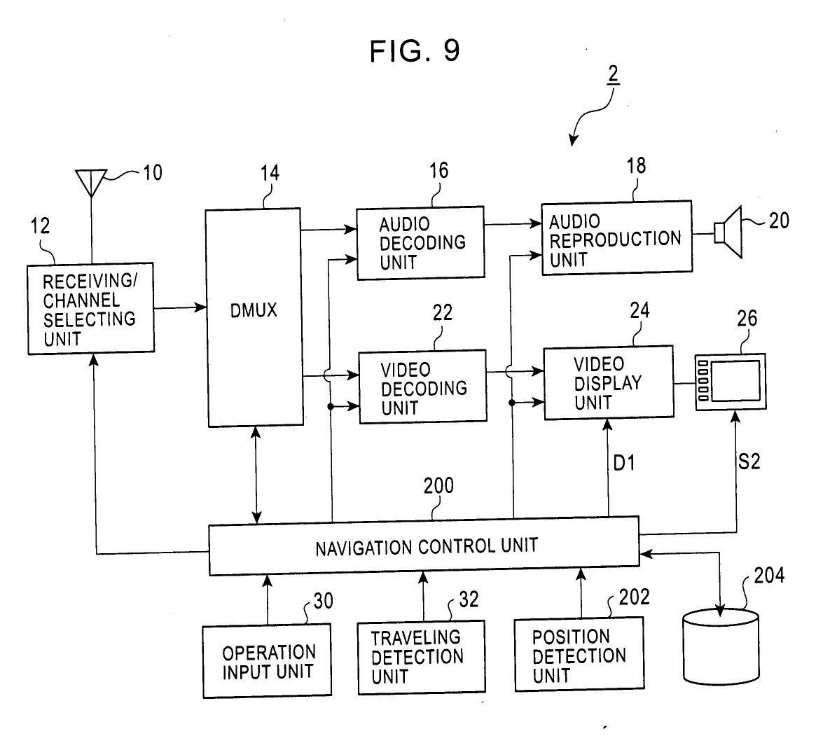

FIG. 9 is a block diagram of an in-vehicle navigation apparatus 2 according to the second embodiment. The in-vehicle navigation apparatus 2 has a navigation function in addition to the function of the digital broadcast receiving apparatus according to the first embodiment.

The in-vehicle navigation apparatus 2 further includes a position detection unit 202 and a map database 204 in addition to the components shown in FIG. 1. A navigation control unit 200 controls the display of a digital broadcast and the display of a map for navigation. The position detection unit 202 includes a global positioning system (GPS) receiver and an autonomous navigation sensor including a gyro sensor, and detects the vehicle position. The map database 204 stores data of roads, maps, etc., necessary for navigation.

The navigation control unit 200 obtains vehicle position information from the position detection unit 202, and retrieves map data around the vehicle position from the database 204. The retrieved data is supplied to the video display unit 24 over a data line D1, and is then modified into desired frame data before it is displayed on the display 26. When the user instructs searching for a route to the destination through the operation input unit 30, the navigation control unit 200 searches for the optimum route to the destination, and displays the route on the display 26 to guide the user along the displayed route.

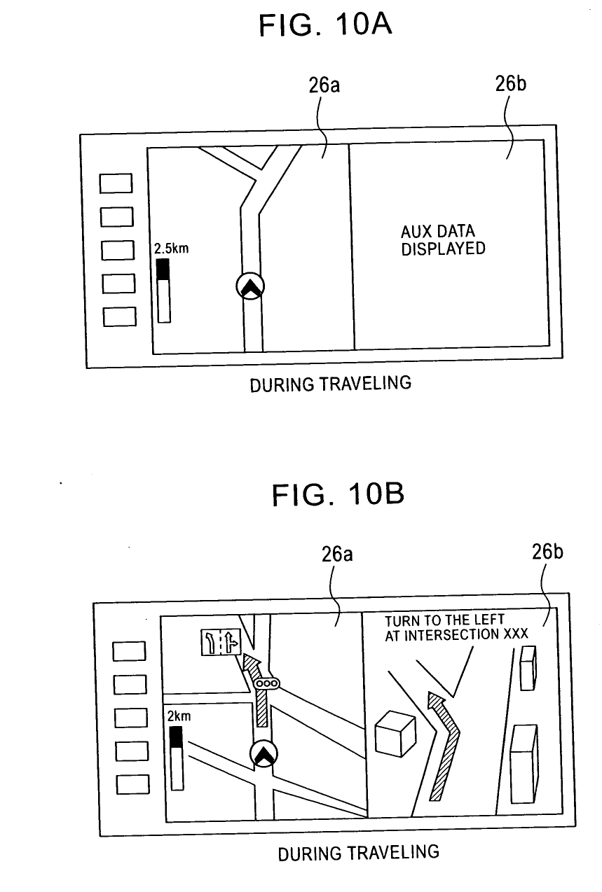

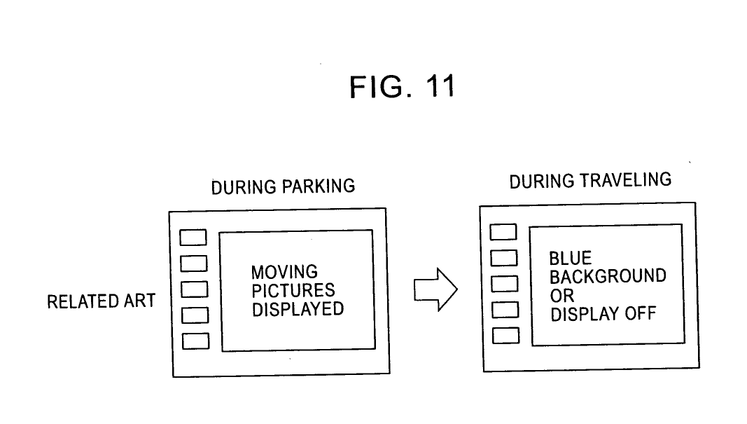

FIGS. 10A and 10B show display views on the display 26 according to the second embodiment. When the vehicle is traveling, as shown in FIG. 10A, the route guidance to the destination is shown on a screen 26a of the display 26, and the auxiliary data received in the digital broadcast is displayed on another screen 26b of the display 26. When the vehicle position is near an intersection while traveling on the route to the destination, the navigation control unit 200 controls the video display unit 24 to switch the viewing mode of the screen 26b from the auxiliary data mode to the expanded intersection guidance mode, as shown in FIG. 10B. After the vehicle has passed the intersection, the screen 26b is controlled to switch its viewing mode from the expanded intersection guidance mode to the auxiliary data mode.

When the user instructs displaying the digital broadcast through the operation input unit 30, the navigation control unit 200 may cause the display 26 to be divided into two screens so that the digital broadcast is displayed on one screen and a map for navigation, etc., is displayed on the other screen. In this case, all images including moving pictures are displayed when the vehicle is parked, and the auxiliary data for the digital broadcast is displayed on the display 26 when the vehicle is traveling.

Such display control allows the user to enjoy data services provided by digital broadcasting while acquiring information necessary for navigation.

The in-vehicle electronic apparatus according to the present invention may be implemented as an in-vehicle navigation apparatus, an in-vehicle digital broadcast receiving apparatus, an in-vehicle audio and video (AV) apparatus, an in-vehicle computer apparatus, or an apparatus or system having one or a plurality of these apparatuses connected thereto. The in-vehicle electronic apparatus according to the present invention may also be implemented as a system having a combination of these functions.

While preferred embodiments of the present invention have been described in detail, the present invention is not limited to these specific embodiments, and a variety of modifications and variations may be made without departing from the scope of the present invention set forth in the appended claims.

1. An in-vehicle electronic apparatus having a function for receiving a digital broadcast, the in-vehicle electronic apparatus comprising:
a display;
a traveling detection unit that determines whether or not a vehicle in which the in-vehicle electronic apparatus is installed is traveling;
an auxiliary data extraction unit that extracts auxiliary data other than moving picture data from received digital broadcast data; and
a display control unit that causes the auxiliary data extracted by the auxiliary data extraction unit to be displayed on the display when the traveling detection unit determines that the vehicle is traveling.

2. The in-vehicle electronic apparatus according to claim 1, wherein the display control unit receives the moving picture data and the auxiliary data, and selectively outputs at least one of the moving picture data and the auxiliary data according to a determination result of the traveling detection unit.

3. The in-vehicle electronic apparatus according to claim 1, wherein the auxiliary data includes an electronic program guide for a broadcast station.

4. The in-vehicle electronic apparatus according to claim 1, wherein the traveling detection unit determines whether or not the vehicle is traveling based on at least one of speed information and parking information of the vehicle.

5. The in-vehicle electronic apparatus according to claim 1, wherein the auxiliary data includes at least one of text data and still image data.

6. The in-vehicle electronic apparatus according to claim 5, wherein the auxiliary data includes an electronic program guide for a broadcast station.

7. The in-vehicle electronic apparatus according to claim 1, further comprising a navigation unit that provides guidance on a road map for an area around the position of the vehicle,
wherein the display control unit causes the road map and the auxiliary data to be displayed on different screens of the display when the vehicle is traveling.

8. The in-vehicle electronic apparatus according to claim 7, wherein the display control unit switches from viewing of the auxiliary data to viewing of intersection guidance when intersection navigation is displayed by the navigation unit.

9. The in-vehicle electronic apparatus according to claim 7, wherein the display control unit causes a moving picture and the road map to be displayed on the different screens of the display when the vehicle is parked.

10. The in-vehicle electronic apparatus according to claim 7, further comprising an input unit,
wherein the display control unit causes at least one of navigation guidance and data received by digital broadcasting to be shown on the display according to an input from the input unit.

11. A method for displaying an image in an in-vehicle electronic apparatus having a function for receiving a digital broadcast, the method comprising:
determining whether or not a vehicle in which the in-vehicle electronic apparatus is installed is traveling; and
displaying auxiliary data other than moving picture data included in a received digital broadcast on a display when it is determined that the vehicle is traveling.

12. The method according to claim 11, further comprising determining whether or not the received digital broadcast includes auxiliary data,
wherein a predetermined image is displayed on the display when the received digital broadcast does not include the auxiliary data.

13. The method according to claim 11, further comprising displaying the moving picture data included in the digital broadcast on the display when it is determined that the vehicle is parked.

14. The method according to claim 11, further comprising extracting the auxiliary data from the received digital broadcast.

15. The method according to claim 14, wherein it is determined whether or not the received digital broadcast includes auxiliary data when the vehicle is traveling, and when it is determined that the received digital broadcast includes the auxiliary data, the auxiliary data is extracted.

16. The method according to claim 11, further comprising displaying a road map for an area around the position of the vehicle on a first screen of the display and the auxiliary data on a second screen of the display.

17. The method according to claim 16, further comprising switching from viewing of the auxiliary data to viewing of intersection guidance on the second screen of the display when the position of the vehicle is near an intersection on a guided route.

18. The method according to claim 16, further comprising displaying the road map and image data received by digital broadcasting on the first and second screens of the display in response to an operation input.
